(19) United States
(12) Patent Application Publication
(10) Pub. No.: US 2026/0358581 A1
(43) Pub. Date: Nov. 12, 2026

(54) OPTOELECTRONIC DEVICE AND MANUFACTURING METHOD THEREOF

(71) Applicant: SILICONWARE PRECISION INDUSTRIES CO., LTD., Taichung City (TW)

(72) Inventors: Chen-Hsien HUANG, Taichung City (TW); Wen-Yu TENG, Taichung City (TW); Liang-Yi HUNG, Taichung City (TW); Cheng-Yu KANG, Taichung City (TW); Yu-Po WANG, Taichung City (TW)

(73) Assignee: SILICONWARE PRECISION INDUSTRIES CO., LTD., Taichung City (TW)

(21) Appl. No.: 19/418,409

(22) Filed: Dec. 12, 2025

(30) Foreign Application Priority Data
May 7, 2025 (TW) 114117175

(51) Int. Cl. G02B 6/42

(52) U.S. Cl. CPC G02B 6/4239; G02B 6/4231; G02B 6/4244

(57) ABSTRACT

Provided are an optoelectronic device and a method of manufacturing the optoelectronic device. An optical engine chip is provided. An optical fiber connector is disposed on the optical engine chip via an adhesive layer. The adhesive layer includes a glue material and spacers. The optical fiber connector is fixed to the optical engine chip via the glue material of the adhesive layer. A gap between the optical fiber connector and the optical engine chip is maintained by the spacers of the adhesive layer.

### BACKGROUND

### 1. Technical Field

The present disclosure relates to a semiconductor device, and more particularly, to an optoelectronic device and a manufacturing method thereof.

### 2. Description of Related Art

With the vigorous development of the electronics industry, electronic products are gradually moving towards multi-functionality and high performance. At present, the application of the fifth generation (5G) communication technology has expanded to the fields of Internet of Things (IoT), Industrial Internet of Things (IIoT), cloud, artificial intelligence (AI), autonomous cars, and medical care. As the application level expands, a large amount of data will be generated in the process and needs to be efficiently transmitted, calculated, and stored. Therefore, in recent years, the demand for data transmission in large data centers and cloud servers has emerged in large quantities, and the industry has begun to enter the field of optical communications, using “light” instead of “electricity” as the carrier of data transmission. In this context, co-packaged optics (CPO) has become the development trend of future semiconductor and packaging technology.

In the existing manufacturing process of the co-packaged optical components, the efficient and precise bonding of the optical fiber connector (receptacle) and the optical engine chip (OE chip) has become the key to improve signal transmission efficiency. If the optical fiber connector and the optical engine chip are not aligned properly, the optical signal transmitted via the optical fiber into the optical engine chip may be attenuated, distorted, or leaked. However, the distance between the optical fiber connector and the optical engine chip is usually controlled/maintained by ultraviolet-curable glue (UV-curable glue). Since UV-curable glue is in pure liquid state, uneven coating of UV-curable glue and shrinkage of the light-cured glue will cause uneven bonding, resulting in inaccurate spacing control, causing the optical fiber connector to shift, thereby affecting the optical alignment accuracy and signal transmission efficiency.

Therefore, how to overcome the above-mentioned drawbacks of the prior art has become an urgent issue to be solved.

### SUMMARY

In order to address the above-mentioned problems of the prior art, the present disclosure provides an optoelectronic device, and the optoelectronic device comprises: an optical engine chip; an optical fiber connector disposed on the optical engine chip; and an adhesive layer disposed between the optical engine chip and the optical fiber connector and including a glue material and spacers, wherein the optical fiber connector is fixed to the optical engine chip via the glue material of the adhesive layer, and a gap between the optical fiber connector and the optical engine chip is maintained by the spacers of the adhesive layer.

The present disclosure further provides a method of manufacturing an optoelectronic device, and the method comprises: providing an optical engine chip; and disposing an optical fiber connector on the optical engine chip via an adhesive layer, wherein the adhesive layer includes a glue material and spacers, the optical fiber connector is fixed to the optical engine chip via the glue material of the adhesive layer, and a gap between the optical fiber connector and the optical engine chip is maintained by the spacers of the adhesive layer.

In the aforementioned optoelectronic device and method, the adhesive layer is first applied to the optical engine chip, and then the optical fiber connector is disposed on the optical engine chip via the adhesive layer.

In the aforementioned optoelectronic device and method, the adhesive layer is first applied to the optical fiber connector, and then the optical fiber connector is disposed on the optical engine chip via the adhesive layer.

In the aforementioned optoelectronic device and method, the optical fiber connector is formed with a through-opening that serves as an optical channel.

In the aforementioned optoelectronic device and method, the optical engine chip integrates an electronic integrated circuit and a photonic integrated circuit.

In the aforementioned optoelectronic device and method, the glue material is ultraviolet-curable glue.

In the aforementioned optoelectronic device and method, the spacers are made of divinylbenzene or acrylates copolymer.

In the aforementioned optoelectronic device and method, the present disclosure further comprises: forming a plurality of conductive elements on the optical engine chip.

Therefore, in the optoelectronic device and the manufacturing method thereof of the present disclosure, the spacers are uniformly mixed into the glue material of the adhesive layer between the optical engine chip and the optical fiber connector. This arrangement controls the gap between the optical channels, ensuring that when the optical fiber connector is bonded to the optical engine chip, a fixed gap and high flatness are maintained. This effectively mitigates the signal transmission losses caused by uneven gaps in conventional bonding processes.

### BRIEF DESCRIPTION OF THE DRAWINGS

FIG. 1A to FIG. 1C are schematic views illustrating a method for manufacturing an optoelectronic device according to a first embodiment of the present disclosure.

FIG. 2A to FIG. 2C are schematic views illustrating a method for manufacturing an optoelectronic device according to a second embodiment of the present disclosure.

FIG. 3 is a schematic cross-sectional view of a co-packaged optical component employing the optoelectronic devices according to the present disclosure.

### DETAILED DESCRIPTION

The following describes the embodiments of the present disclosure with examples. Those skilled in the art can easily understand other advantages and effects of the present disclosure from the contents disclosed in this specification.

It should be understood that, the structures, ratios, sizes, and the like in the accompanying figures are used for illustrative purposes to facilitate the perusal and comprehension of the contents disclosed in the present specification by one skilled in the art, rather than to limit the conditions for practicing the present disclosure. Any modification of the structures, alteration of the ratio relationships, or adjustment of the sizes without affecting the possible effects and achievable proposes should still be deemed as falling within the scope defined by the technical contents disclosed in the present specification. Meanwhile, terms such as “first,” “second,” “at least one,” “a,” “one,” and the like are merely for clear explanation rather than limiting the practicable scope of the present disclosure, and thus, alterations or adjustments of the relative relationships thereof without essentially altering the technical contents should still be considered in the practicable scope of the present disclosure.

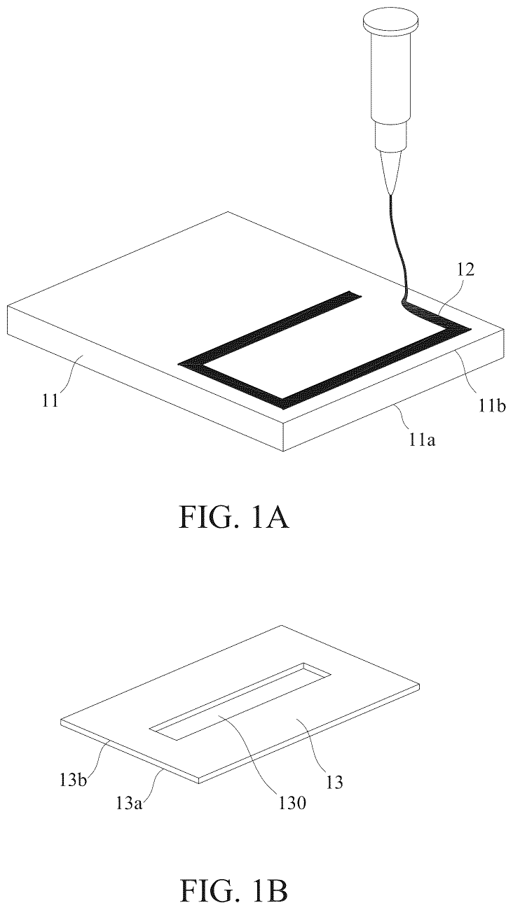

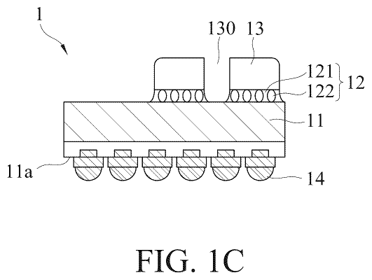

Please refer to FIG. 1A to FIG. 1C, which are schematic views illustrating a method for manufacturing an optoelectronic device according to a first embodiment of the present disclosure. As shown in FIG. 1A, an optical engine chip 11 is provided. The optical engine chip 11 has a first side 11a and a second side 11b opposite to the first side 11a. An adhesive layer 12 is formed on the second side 11b of the optical engine chip 11.

The optical engine chip 11, for example, integrates an electronic integrated circuit (EIC) and a photonic integrated circuit (PIC), wherein the photonic integrated circuit is configured to transmit and receive optical signals, and the electronic integrated circuit is electrically connected to the photonic integrated circuit to perform conversion between optical signals and electronic signals.

The adhesive layer 12 consists of a glue material 121 (such as ultraviolet-curable glue) with spacers 122 added to the glue material 121 (as shown in FIG. 1C). The spacers 122 are, for example, made of divinylbenzene or acrylates copolymer.

As shown in FIG. 1B, an optical fiber connector 13 is provided and has a first surface 13a and a second surface 13b opposite to the first surface 13a. An opening 130 (e.g., a through-opening or a through-hole) is formed at an intermediate position and penetrates through the first surface 13a and the second surface 13b to serve as an optical channel.

As shown in FIG. 1C, the first surface 13a of the optical fiber connector 13 is disposed on the second side 11b of the optical engine chip 11, so that the optical fiber connector 13 is fixed to the optical engine chip 11 via the glue material 121 of the adhesive layer 12, and a gap between the optical fiber connector 13 and the optical engine chip 11 is controlled/maintained by the spacers 122 of the adhesive layer 12, thereby obtaining the optoelectronic device 1.

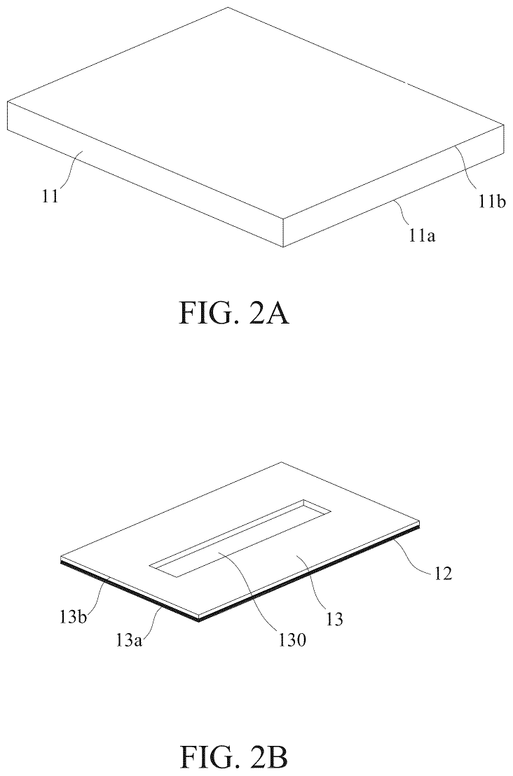

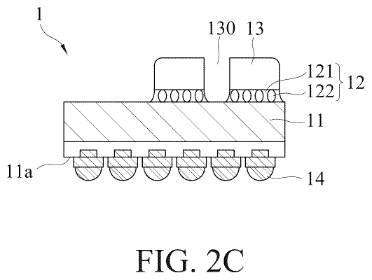

Please refer to FIG. 2A to FIG. 2C, which are schematic views illustrating a method for manufacturing an optoelectronic device according to a second embodiment of the present disclosure. As shown in FIG. 2A, an optical engine chip 11 is provided and has a first side 11a and a second side 11b opposite to the first side 11a. The optical engine chip 11 integrates an electronic integrated circuit (EIC) and a photonic integrated circuit (PIC).

As shown in FIG. 2B, an optical fiber connector 13 is provided and has a first surface 13a and a second surface 13b opposite to the first surface 13a. An opening 130 (e.g., a through-opening or a through-hole) is formed at an intermediate position and penetrates through the first surface 13a and the second surface 13b. An adhesive layer 12 is formed on the periphery of the first surface 13a. The adhesive layer 12 consists of a glue material 121 with spacers 122 added to the glue material 121 (as shown in FIG. 2C).

As shown in FIG. 2C, the optical fiber connector 13 is disposed on the second side 11b of the optical engine chip 11 via the adhesive layer 12, thereby obtaining the optoelectronic device 1.

Through the above-mentioned manufacturing method, the present disclosure further provides an optoelectronic device 1, which comprises an optical engine chip 11, an optical fiber connector 13 disposed on the optical engine chip 11, and an adhesive layer 12 disposed between the optical engine chip 11 and the optical fiber connector 13.

The optical engine chip 11 has a first side 11a and a second side 11b opposite to the first side 11a.

The optical fiber connector 13 is disposed on the second side 11b of the optical engine chip 11. The optical fiber connector 13 has a first surface 13a and a second surface 13b opposite to the first surface 13a, and is formed with an opening 130 (e.g., a through-opening or a through-hole) penetrating through the first surface 13a and the second surface 13b to serve as an optical channel.

The adhesive layer 12 includes a glue material 121 and spacers 122 added to the glue material 121. The spacers 122 are, for example, made of divinylbenzene or acrylates copolymer. Under applied pressure, the spacers 122 can be uniformly dispersed (without agglomeration) in the glue material 121. The particle size of the spacers 122 helps control/maintain the gap between the optical fiber connector 13 and the optical engine chip 11. In addition, since the spacers 122 have a uniform size and high strength, the gap variations caused by pressure or shrinkage after curing can be effectively prevented. At the same time, the spacers 122 can disperse evenly without agglomeration, and can be evenly distributed in the glue material 121 to provide a flat and stable support.

In addition, a plurality of conductive elements 14 such as solder balls may be disposed on the first side 11a of the optical engine chip 11, so that the optoelectronic device 1 can be connected to an external device via the plurality of conductive elements 14.

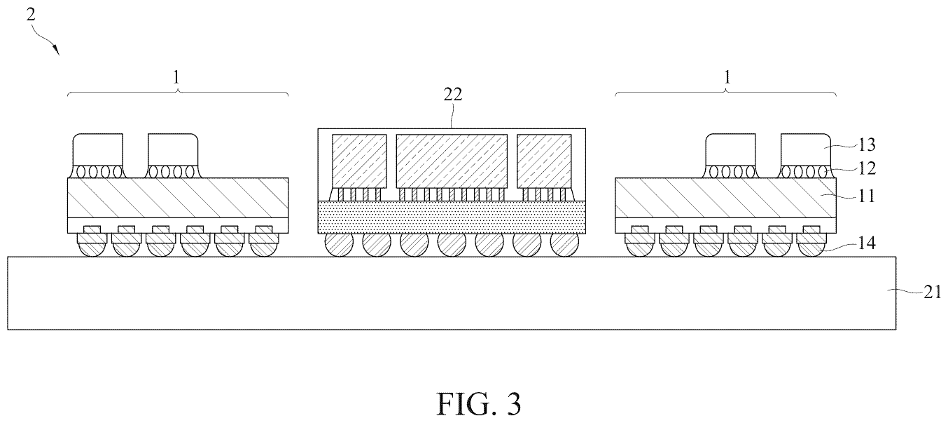

Referring to FIG. 3, a plurality of the optoelectronic devices 1 may be subsequently placed on a circuit board 21 via the plurality of conductive elements 14 on the first side 11a of the optical engine chip 11. In addition, a package module 22 is disposed at the center of the circuit board 21. The package module 22 may include active elements such as a switch chip, a system on a chip (SoC), a high bandwidth memory (HBM) chip, or other functional chips, or the package module 22 may also include passive elements such as resistors, capacitors, or inductors. Furthermore, the plurality of optoelectronic devices 1 (the optical engine chips 11) are disposed around the package module 22 to form a co-packaged optical component 2.

To sum up, in the optoelectronic device and the manufacturing method thereof of the present disclosure, the spacers are uniformly mixed into the glue material of the adhesive layer between the optical engine chip and the optical fiber connector. This arrangement controls the gap between the optical channels, ensuring that when the optical fiber connector is bonded to the optical engine chip, a fixed gap and high flatness are maintained. This effectively mitigates the signal transmission losses caused by uneven gaps in conventional bonding processes. Moreover, the above-mentioned optoelectronic device and manufacturing method are not only simple to implement, but also have high technical feasibility, and can fully address the problems of the prior art.

The foregoing embodiments are provided for the purpose of illustrating the principles and effects of the present disclosure, rather than limiting the present disclosure. Anyone skilled in the art can modify and alter the above embodiments without departing from the spirit and scope of the present disclosure. Therefore, the scope of protection with regard to the present disclosure should be as defined in the accompanying claims listed below.

What is claimed is:

1. An optoelectronic device, comprising:
an optical engine chip;
an optical fiber connector disposed on the optical engine chip; and
an adhesive layer disposed between the optical engine chip and the optical fiber connector and including a glue material and spacers, wherein the optical fiber connector is fixed to the optical engine chip via the glue material of the adhesive layer, and a gap between the optical fiber connector and the optical engine chip is maintained by the spacers of the adhesive layer.

2. The optoelectronic device of claim 1, wherein the optical fiber connector is formed with a through-opening that serves as an optical channel.

3. The optoelectronic device of claim 1, wherein the optical engine chip integrates an electronic integrated circuit and a photonic integrated circuit.

4. The optoelectronic device of claim 1, wherein the glue material is ultraviolet-curable glue.

5. The optoelectronic device of claim 1, wherein the spacers are made of divinylbenzene or acrylates copolymer.

6. The optoelectronic device of claim 1, further comprising: a plurality of conductive elements disposed on the optical engine chip.

7. A method of manufacturing an optoelectronic device, comprising:
providing an optical engine chip; and
disposing an optical fiber connector on the optical engine chip via an adhesive layer, wherein the adhesive layer includes a glue material and spacers, the optical fiber connector is fixed to the optical engine chip via the glue material of the adhesive layer, and a gap between the optical fiber connector and the optical engine chip is maintained by the spacers of the adhesive layer.

8. The method of claim 7, wherein the adhesive layer is first applied to the optical engine chip, and then the optical fiber connector is disposed on the optical engine chip via the adhesive layer.

9. The method of claim 7, wherein the adhesive layer is first applied to the optical fiber connector, and then the optical fiber connector is disposed on the optical engine chip via the adhesive layer.

10. The method of claim 7, wherein the optical fiber connector is formed with a through-opening that serves as an optical channel.

11. The method of claim 7, wherein the optical engine chip integrates an electronic integrated circuit and a photonic integrated circuit.

12. The method of claim 7, wherein the glue material is ultraviolet-curable glue.

13. The method of claim 7, wherein the spacers are made of divinylbenzene or acrylates copolymer.

14. The method of claim 7, further comprising: forming a plurality of conductive elements on the optical engine chip.
